(19) United States
(12) Patent Application Publication
(10) Pub. No.: US 2022/0277891 A1
(43) Pub. Date: Sep. 1, 2022

(54) INTEGRATED MAGNETIC DEVICE

(71) Applicant: INVENTRONICS (HANGZHOU), INC., Hangzhou, Zhejiang (CN)

(72) Inventors: Delai JIANG, Hangzhou, Zhejiang (CN); Defei XU, Hangzhou, Zhejiang (CN)

(73) Assignee: INVENTRONICS (HANGZHOU), INC., Hangzhou, Zhejiang (CN)

(21) Appl. No.: 17/627,132

(22) PCT Filed: Dec. 27, 2019
(86) PCT No.: PCT/CN2019/129079

§ 371 Date: Jan. 14, 2022

(30) Foreign Application Priority Data
Jul. 19, 2019 (CN) 201921145708.0

(51) Int. Cl. H01F 27/32; H01F 27/24

(52) U.S. Cl. CPC H01F 27/325; H01F 27/24

(57) ABSTRACT

An integrated magnetic device includes a bobbin having a through hole. A center column magnetic core groove is arranged in the middle of the bobbin to divide the bobbin into a first bobbin and a second bobbin, the center column magnetic core groove is inserted with a center column magnetic core, the first bobbin and the second bobbin are both provided with a side magnetic core for forming a closed loop with the center column magnetic core, the side magnetic core includes a center column inserted in the through hole, a first winding groove for winding a magnetic device winding of a Boost circuit is provided between side walls of the first bobbin, and a second winding groove for winding a magnetic device winding of an LLC circuit is provided between side walls of the second bobbin.

This application claims priority to Chinese Patent Application No. 201921145708.0, titled “INTEGRATED MAGNETIC DEVICE”, filed on Jul. 19, 2019 with the China National Intellectual Property Administration, which is incorporated herein by reference in its entirety.

### FIELD

The present disclosure relates to the technical field of magnetic devices, and in particular, to an integrated magnetic device.

### BACKGROUND

Driving power supplies have many different circuit topologies, such as Buck, Boost, Flyback, Boost plus Flyback or Boost plus LLC and so on. Magnetic devices are indispensable components in a driving power supply, and there may be multiple magnetic devices in a two-stage circuit, that is, a combination of two topologies. Assuming that one driving power supply is implemented by adopting a two-stage scheme, a topology in a first stage is a Boost circuit and a topology in a second stage is an LLC resonant circuit, then the driving power supply includes three magnetic devices: an inductance of Boost, a resonant inductance and a transformer of LLC. Magnetic devices are relatively expensive devices in driving power supplies. The cost of magnetic devices includes both the material cost and the labor cost since magnetic devices require manual winding during production. Thus as the number of magnetic devices goes up, the labor cost of the driving power supply will increase exponentially.

The integration of magnetic devices in the conventional technology usually refers to the integration of magnetic devices in a same circuit topology. Different topologies contain separate and different magnetic devices, and each magnetic device requires a worker to perform separate coil winding and packaging. Thus the labor cost and material cost of the magnetic devices are very high.

Therefore, how to reduce the labor cost and material cost of the magnetic devices is an urgent problem to be solved by those skilled in the art.

### SUMMARY

In view of the above, an objective of the present disclosure is to provide an integrated magnetic device, which integrates a magnetic device of a Boost circuit and a magnetic device of an LLC circuit, such that only one time of manual winding and packaging is required for original workload of two magnetic devices, thereby saving the labor cost and material cost of the magnetic devices greatly.

In order to achieve the above objective, the following technical solutions are provided according to the present disclosure.

An integrated magnetic device is provided, including a bobbin having a through hole, where: a center column magnetic core groove is arranged in the middle of the bobbin to divide the bobbin into a first bobbin and a second bobbin, the center column magnetic core groove is inserted with a center column magnetic core, the first bobbin and the second bobbin are both provided with a side magnetic core for forming a closed loop with the center column magnetic core, the side magnetic core includes a center column inserted in the through hole, a first winding groove for winding a magnetic device winding of a Boost circuit is provided between side walls of the first bobbin, and a second winding groove for winding a magnetic device winding of an LLC circuit is provided between side walls of the second bobbin.

Preferably, a baffle for holding the center column magnetic core is provided on one side of the center column magnetic core groove, and another side of the center column magnetic core groove is an opening, such that the center column magnetic core is inserted into the center column magnetic core groove through the opening.

Preferably, the center column magnetic core is a cuboid platelike magnetic core.

Preferably, the side magnetic core is an E-shaped magnetic core, a center column of the E-shaped magnetic core is inserted into the through hole, two side columns on both sides of the E-shaped magnetic core are located outside the bobbin, and end faces of the two side columns on both sides of the E-shaped magnetic core abut against the center column magnetic core.

Preferably, there is a gap between the center column and the center column magnetic core.

Preferably, the bobbin is further provided with a lead-out pin area for leading out a winding wire, and the lead-out pin area is provided at one end of the bobbin, such that the bobbin has a vertical structure.

Preferably, two ends of the bobbin are both provided with a lead-out pin area for leading out a winding wire under the through hole, such that the bobbin has a horizontal structure.

Preferably, an upper end surface of the lead-out pin area is flush with an outer edge of the through hole, for placing the side magnetic core inserted into the through hole.

Preferably, the second winding groove includes a third winding groove and a fourth winding groove separated by a baffle wall.

Preferably, the baffle wall is provided with a C-shaped magnetic core groove for inserting the C-shaped magnetic core.

In the integrated magnetic device according to the present disclosure, during manufacture processes, a magnetic device winding of a Boost circuit is wound in a first winding groove on a first bobbin, and a magnetic device winding of an LLC circuit is wound in a second winding groove on a second bobbin, and lead wires of the windings are led out from a lead-out pin area of the bobbin. A center column magnetic core is inserted into a center column magnetic core groove in the middle of the bobbin. Center columns of two side magnetic cores are respectively inserted into the through hole from outer ends of the first bobbin and the second bobbin, and the two side magnetic cores respectively form closed loops with the center column magnetic core for conduction of magnetic flux. Therefore, the side magnetic core inserted into the first bobbin and one side of the center column magnetic core constitute a magnetic loop for the Boost circuit, the side magnetic core inserted into the second bobbin and another side of the center column magnetic core constitute a magnetic loop for the LLC circuit, and the magnetic loops of the two magnetic core devices do not interfere with each other, so that the magnetic device of the Boost circuit and the magnetic device of the LLC circuit are integrated into one. In a production process, only one time of manual winding and packaging is required. Compared with the conventional technology that requires separate winding and packaging for the two magnetic devices, the labor cost and material cost are greatly reduced, and the cost of driving power supplies is lowered.

### BRIEF DESCRIPTION OF THE DRAWINGS

In order to more clearly illustrate technical solutions in embodiments of the present disclosure or in the conventional technology, drawings used in the description of the embodiments or the conventional technology are introduced briefly hereinafter. Apparently, the drawings described in the following illustrate some embodiments of the present disclosure; other drawings may be obtained by those ordinarily skilled in the art based on these drawings without any creative efforts.

FIG. 1 is a schematic diagram of an integrated magnetic device according to an embodiment of the present disclosure;

FIG. 2 is a schematic diagram of a bobbin in FIG. 1;

FIG. 3 is a schematic diagram of a center column magnetic core and an E-shaped magnetic core in FIG. 1; and

FIG. 4 is a schematic diagram of a bobbin according to an embodiment.

### REFERENCE SIGNS

| | |
|---|---|
| 1: | Bobbin; |
| 2: | E-shaped magnetic core; |
| 3: | Lead-out pin area; |
| 4: | First winding groove; |
| 5: | Center column magnetic core; |
| 6: | Third winding groove; |
| 7: | Fourth winding groove; |
| 8: | Baffle wall; |
| 9: | Center column magnetic core groove; |
| 10: | Baffle; |
| 11: | First bobbin; |
| 12: | Second bobbin; |
| 13: | Through hole; |
| 14: | C-shaped magnetic core groove. |

### DETAILED DESCRIPTION

The technical solutions in the embodiments of the present disclosure will be described clearly and completely hereinafter in conjunction with the drawings in the embodiments of the present disclosure. Apparently, the described embodiments are only a part of the embodiments of the present disclosure, rather than all embodiments. Based on the embodiments in the present disclosure, all of other embodiments, made by the person skilled in the art without any creative efforts, fall into the scope of protection of the present disclosure.

An objective of the present disclosure is to provide an integrated magnetic device, which integrates a magnetic device of a Boost circuit and a magnetic device of an LLC circuit, such that only one time of manual winding and packaging is required for original workload of two magnetic devices, thereby saving the labor cost and material cost of the magnetic devices greatly.

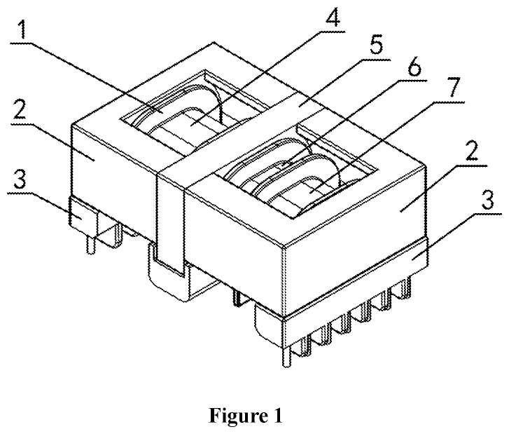

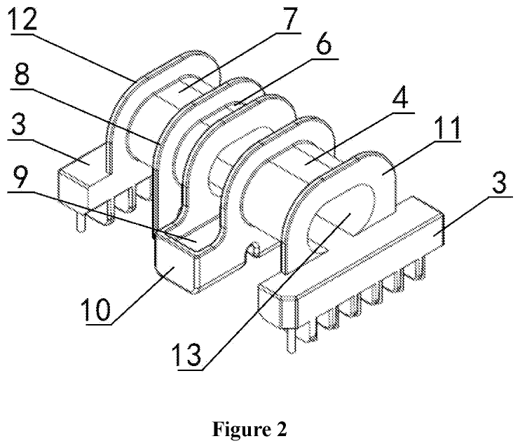

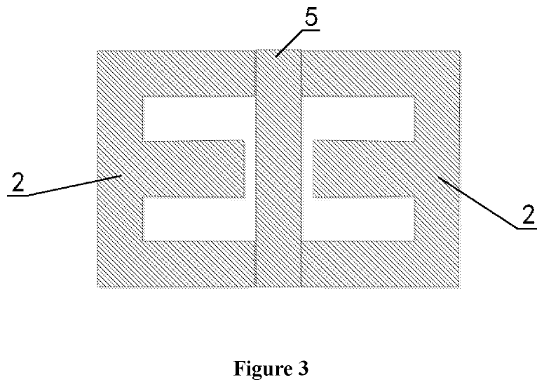

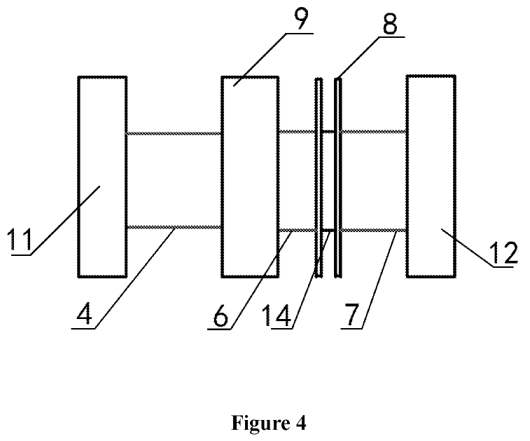

Referring to FIGS. 1 to 4, FIG. 1 is a schematic diagram of an integrated magnetic device according to an embodiment of the present disclosure; FIG. 2 is a schematic diagram of a bobbin in FIG. 1; FIG. 3 is a schematic diagram of a center column magnetic core and an E-shaped magnetic core in FIG. 1; and FIG. 4 is a schematic diagram of a bobbin according to an embodiment.

An integrated magnetic device according to the present disclosure includes a bobbin 1 having a through hole 13, where: a center column magnetic core groove 9 is arranged in the middle of the bobbin 1 to divide the bobbin 1 into a first bobbin 11 and a second bobbin 12, the center column magnetic core groove 9 is inserted with a center column magnetic core 5, the first bobbin 11 and the second bobbin 12 are both provided with a side magnetic core for forming a closed loop with the center column magnetic core 5, the side magnetic core includes a center column inserted in the through hole 13, a first winding groove 4 for winding a magnetic device winding of a Boost circuit is provided between side walls of the first bobbin 11, and a second winding groove for winding a magnetic device winding of an LLC circuit is provided between side walls of the second bobbin 12. The bobbin 1 is further provided with a lead-out pin area 3 for leading out a winding wire.

The bobbin 1 is a carrier for winding coils and placing magnetic cores. The bobbin 1 may have a cylindrical structure. The bobbin 1 is provided with the through hole 13 for inserting a magnetic core, and the through hole 13 may penetrate the bobbin 1 along a lengthwise direction of the bobbin 1. The center column magnetic core groove 9 is provided in the middle of the bobbin 1, and divides the bobbin 1 into the first bobbin 11 and the second bobbin 12, which are located on two sides of the center column magnetic core groove 9. The first winding groove 4 is provided between the side walls of the first bobbin 11, and is used to wind the magnetic device winding of the Boost circuit; for example, an inductance winding of the Boost circuit may be wound on the first winding groove 4. The second winding groove is provided between the side walls of the second bobbin 12, and is used to wind the magnetic device winding of the LLC circuit; for example, the second winding groove may be used to wind a primary winding and a secondary winding of a transformer of the LLC circuit.

The center column magnetic core groove 9 is inserted with the center column magnetic core 5, and the first bobbin 11 and the second bobbin 12 are inserted with side magnetic cores. Two side magnetic cores respectively form closed loops with the center column magnetic core 5 for conduction of magnetic flux. Center columns of the two side magnetic cores are respectively inserted into the through hole 13 of the first bobbin 11 and the second bobbin 12 from outer ends of the first bobbin 11 and the second bobbin 12. Therefore, a side magnetic core at the first bobbin 11 and one side of the center column magnetic core 5 constitute a magnetic device of the Boost circuit, and a side magnetic core at the second bobbin 12 and another side of the center column magnetic core 5 constitute a magnetic device of the LLC circuit.

Thus, in the integrated magnetic device according to the present disclosure, during manufacture processes, a magnetic device winding of a Boost circuit is wound in a first winding groove 4 on a first bobbin 11, and a magnetic device winding of an LLC circuit is wound in a second winding groove on a second bobbin 12, and lead wires of the windings are led out from a lead-out pin area 3 of the bobbin 1. A center column magnetic core 5 is inserted into a center column magnetic core groove 9 in the middle of the bobbin 1. Center columns of two side magnetic cores are respectively inserted into the through hole 13 from outer ends of the first bobbin 11 and the second bobbin 12, and the two side magnetic cores respectively form closed loops with the center column magnetic core 5 for conduction of magnetic flux. Therefore, the side magnetic core inserted into the first bobbin 11 and one side of the center column magnetic core 5 constitute a magnetic loop for the Boost circuit, the side magnetic core inserted into the second bobbin 12 and another side of the center column magnetic core 5 constitute a magnetic loop for the LLC circuit, and the magnetic loops of the two magnetic core devices do not interfere with each other, so that the magnetic device of the Boost circuit and the magnetic device of the LLC circuit are integrated into one. In a production process, only one time of manual winding and packaging is required. Compared with the conventional technology that requires separate winding and packaging for the two magnetic devices, the labor cost and material cost are greatly reduced, and the cost of driving power supplies is lowered.

On the basis of the above-described embodiment, regarding a specific arrangement of the center column magnetic core groove 9, preferably, a baffle 10 for holding the center column magnetic core 5 may be provided on one side of the center column magnetic core groove 9, and another side of the center column magnetic core groove 9 is an opening. Thus the center column magnetic core 5 may be pushed into the center column magnetic core groove 9 through the opening of the center column magnetic core groove 9, when inserting the center column magnetic core 5 into the center column magnetic core groove 9, and the baffle 10 of the center column magnetic core groove 9 holds the center column magnetic core 5 to limit a position of the center column magnetic core 5, thereby improving reliability of installation of the center column magnetic core 5.

On the basis of the above-described embodiments, regarding a specific structure of the center column magnetic core 5, preferably, the center column magnetic core 5 may be a cuboid platelike magnetic core. It should be pointed out that a shape and a size of the center column magnetic core groove 9 is matched with a shape and a size of the center column magnetic core 5 since the center column magnetic core groove 9 is used to insert the center column magnetic core 5. Thus the center column magnetic core 5 can be inserted into the center column magnetic core groove 9, and the position thereof is limited by the center column magnetic core groove 9.

On the basis of the above-described embodiments, regarding a specific structure of the side magnetic core, preferably, the side magnetic core is an E-shaped magnetic core 2, and a center column of the E-shaped magnetic core 2 is inserted into the through hole 13, two side columns on both sides of the E-shaped magnetic core 2 are located outside the bobbin 1, and end faces of the two side columns on both sides of the E-shaped magnetic core 2 abut against the center column magnetic core 5. The E-shaped magnetic core 2 and the center column magnetic core 5 form a closed loop. Preferably, there is a gap between the center column of the E-shaped magnetic core 2 and the center column magnetic core 5. By setting different gaps between the center column of the side magnetic core and the center column magnetic core 5, that is, by setting different lengths for the center column of the side magnetic core, inductance of the Boost circuit and inductance of a transformer of the LLC circuit can be adjusted.

On the basis of the above-described embodiments, regarding a specific arrangement of the lead-out pin area 3 on the bobbin 1, preferably, the bobbin 1 is of a horizontal structure. The lead-out pin area 3 is arranged at both ends of the bobbin 1, below the through hole 13, that is, two ends of the bobbin 1 are both provided with a lead-out pin area 3. A lead-out pin area 3 at the first bobbin 11 is a lead-out pin area 3 for a winding led out from a magnetic device of the Boost circuit, and a lead-out pin area 3 at the second bobbin 12 is a lead-out pin area 3 for a winding led out from a magnetic device of the LLC circuit. Alternatively, the bobbin 1 may be of a vertical structure. That is, the lead-out pin area 3 is provided at one end of the bobbin 1. The specific arrangement of the lead-out pin area 3 may be flexibly selected according to requirements.

In this embodiment, in a case that the lead-out pin area 3 is provided at one end of the bobbin 1, the bobbin 1 is of a vertical structure. Alternatively, in a case that the lead-out pin area 3 for leading out a winding wire is provided at both ends of the bobbin 1 below the through hole 13, the bobbin 1 is of a horizontal structure.

On the basis of the above-described embodiments, preferably, an upper end surface of the lead-out pin area 3 may be flush with an outer edge of the through hole 13, such that the side magnetic core may be placed on the upper end surface of the lead-out pin area 3 after inserting the center column of the side magnetic core into the through hole 13, and the upper end surface of the lead-out pin area 3 can support the side magnetic core.

On the basis of any of the above-described embodiments, in order to further flexibly adjust leakage inductance of the magnetic device of the LLC circuit, preferably, the second winding groove includes a third winding groove 6 and a fourth winding groove 7 separated by a baffle wall 8. That is, the baffle wall 8 is provided between the third winding groove 6 and the fourth winding groove 7, such that when a primary winding and a secondary winding of the transformer of the LLC circuit are to be wound, the primary winding and the secondary winding of the transformer of the LLC circuit can be wound in the third winding groove 6 and the fourth winding groove 7 respectively.

On the basis of any of the above-described embodiments, a C-shaped magnetic core is inserted into the baffle wall 8 to increase leakage inductance of the magnetic device of the LLC circuit. A C-shaped magnetic core groove 14 for inserting the C-shaped magnetic core may also be provided on the baffle wall 8 for receiving the C-shaped magnetic core when needed, to increase the leakage inductance of the magnetic device of the LLC circuit. Increased leakage inductance of the magnetic device of the LLC circuit may also be used to replace resonant inductance in the LLC circuit. In addition, the leakage inductance of the magnetic device of the LLC circuit may be adjusted by setting different widths for the baffle wall 8. The wider the baffle wall 8 is, the larger the leakage inductance of the LLC circuit is.

The above embodiments in the specification are described in a progressive manner. Each of the embodiments is mainly focused on describing its differences from other embodiments, and references may be made among these embodiments with respect to the same or similar portions among these embodiments.

The integrated magnetic device according to the present disclosure has been described in detail above. Specific embodiments are used in the specification to illustrate the principle and implementation of the present disclosure, and the description is only used to help understand the method and principle of the present disclosure. It should be noted that for those of ordinary skill in the art, several improvements and modifications can be made to the present disclosure without departing from the principles of the present disclosure, and these improvements and modifications also fall within the scope of protection of the present disclosure.

1. An integrated magnetic device, comprising a bobbin (1) having a through hole (13), wherein: a center column magnetic core groove (9) is arranged in the middle of the bobbin (1) to divide the bobbin (1) into a first bobbin (11) and a second bobbin (12), the center column magnetic core groove (9) is inserted with a center column magnetic core (5), the first bobbin (11) and the second bobbin (12) are both provided with a side magnetic core for forming a closed loop with the center column magnetic core (5), the side magnetic core comprises a center column inserted in the through hole (13), a first winding groove (4) for winding a magnetic device winding of a Boost circuit is provided between side walls of the first bobbin (11), and a second winding groove for winding a magnetic device winding of an LLC circuit is provided between side walls of the second bobbin (12).

2. The integrated magnetic device according to claim 1, wherein one side of the center column magnetic core groove (9) is provided with a baffle (10) for holding the center column magnetic core (5), and another side of the center column magnetic core groove (9) is an opening, whereby the center column magnetic core (5) is inserted into the center column magnetic core groove (9) through the opening.

3. The integrated magnetic device according to claim 2, wherein the center column magnetic core (5) is a cuboid platelike magnetic core.

4. The integrated magnetic device according to claim 1, wherein the side magnetic core is an E-shaped magnetic core (2), a center column of the E-shaped magnetic core (2) is inserted into the through hole (13), and two side columns on both sides of the E-shaped magnetic core (2) are located outside the bobbin, and end faces of the two side columns on both sides of the E-shaped magnetic core (2) abut against the center column magnetic core (5).

5. The integrated magnetic device according to claim 4, wherein there is a gap between the center column and the center column magnetic core (5).

6. The integrated magnetic device according to claim 1, wherein the bobbin (1) is further provided with a lead-out pin area (3) for leading out a winding wire, and the lead-out pin area (3) is provided at one end of the bobbin (1), whereby the bobbin (1) has a vertical structure.

7. The integrated magnetic device according to claim 1, wherein two ends of the bobbin (1) are both provided with a lead-out pin area (3) for leading out a winding wire under the through hole (13), whereby the bobbin (1) has a horizontal structure.

8. The integrated magnetic device according to claim 7, wherein an upper end surface of the lead-out pin area (3) is flush with an outer edge of the through hole (13) for placing the side magnetic core inserted into the through hole (13).

9. The integrated magnetic device according to claim 1, wherein the second winding groove comprises a third winding groove (6) and a fourth winding groove (7) separated by a baffle wall (8).

10. The integrated magnetic device according to claim 9, wherein the baffle wall (8) is provided with a C-shaped magnetic core to increase leakage inductance of a magnetic device of the LLC circuit.

11. The integrated magnetic device according to claim 9, wherein the baffle wall (8) is provided with a C-shaped magnetic core groove (14) for inserting the C-shaped magnetic core.

12. The integrated magnetic device according to claim 2, wherein the second winding groove comprises a third winding groove (6) and a fourth winding groove (7) separated by a baffle wall (8).

13. The integrated magnetic device according to claim 3, wherein the second winding groove comprises a third winding groove (6) and a fourth winding groove (7) separated by a baffle wall (8).

14. The integrated magnetic device according to claim 4, wherein the second winding groove comprises a third winding groove (6) and a fourth winding groove (7) separated by a baffle wall (8).

15. The integrated magnetic device according to claim 5, wherein the second winding groove comprises a third winding groove (6) and a fourth winding groove (7) separated by a baffle wall (8).

16. The integrated magnetic device according to claim 6, wherein the second winding groove comprises a third winding groove (6) and a fourth winding groove (7) separated by a baffle wall (8).

17. The integrated magnetic device according to claim 7, wherein the second winding groove comprises a third winding groove (6) and a fourth winding groove (7) separated by a baffle wall (8).

18. The integrated magnetic device according to claim 8, wherein the second winding groove comprises a third winding groove (6) and a fourth winding groove (7) separated by a baffle wall (8).

19. The integrated magnetic device according to claim 12, wherein the baffle wall (8) is provided with a C-shaped magnetic core to increase leakage inductance of a magnetic device of the LLC circuit.

20. The integrated magnetic device according to claim 12, wherein the baffle wall (8) is provided with a C-shaped magnetic core groove (14) for inserting the C-shaped magnetic core.
